(19) United States
(12) Patent Application Publication
(10) Pub. No.: US 2008/0199065 A1
(43) Pub. Date: Aug. 21, 2008

(54) Method, System and Device for In-Vivo Biopsy

(76) Inventor: Christopher Paul Swain, London (GB)

Correspondence Address: Pearl Cohen Zedek Latzer, LLP, 1500 Broadway, 12th Floor, New York, NY, 10036, US

(21) Appl. No.: 11/579,918

(22) PCT Filed: May 17, 2005
(86) PCT No.: PCT/IL2005/000510

§ 371 Date: Dec. 27, 2007

Related U.S. Application Data
(60) Provisional application No. 60/571,495, filed on May 17, 2004.

(51) Int. Cl. G06K 9/00

(52) U.S. Cl. 382/133

(57) ABSTRACT

A system and method for obtaining a sample from, for example, endo-lumina areas. One or more devices (10-12) may include an imager (16) and a transmitter for transmitter in vivo data, and a sampling mechanism for for example obtaining biopsy.

### FIELD OF THE INVENTION

The invention relates generally to the field of imaging and biopsies of endo-luminal areas, and specifically to capturing images and endo-luminal samples with an autonomous in-vivo device.

### BACKGROUND OF THE INVENTION

The diagnosis and management of many diseases depends on biopsies of tissues taken from abnormal or normal seeming areas of the body. Biopsies, or the taking of samples of cells, endo-luminal liquids and/or tissue are widely used to make the diagnosis of diseases such as, for example, Helicobacter pylori gastritis, celiac disease and Crohn's disease. Typically, these biopsies can be taken in a relatively non specific manner. For some conditions, it is necessary to take biopsies with precision in order to establish the nature of focal abnormalities which may, for example, be malignant. Endoscopy is commonly used to collect biopsy samples however parts of the small intestine are not easily accessible to endoscopy. Furthermore, while endoscopy or surgery may sometimes be used to collect biopsy samples, such procedures can be uncomfortable for the patient, as well as time consuming and expensive to administer.

### SUMMARY OF THE INVENTION

In an embodiment of the invention, there is provided a system for obtaining a sample from within a body lumen. According to one embodiment the system includes a plurality of connected devices; wherein first device comprises an imager and a transmitter for transmitting in vivo data (e.g., image data); and second device comprises a sampling mechanism.

In another embodiment of the invention, there is a method for obtaining a sample from within a body lumen, the method including the steps of: inserting in a body lumen (e.g., the gastrointestinal tract) a plurality of connected devices; wherein one device includes an imager and a transmitter for transmitting image data; and another device includes a sampling mechanism; transmitting images of the other device; and controlling the sampling mechanism, e.g., to obtain a biopsy sample from within the body lumen.

According to some embodiments devices and/or systems according to embodiments of the invention may be swallowable or otherwise inserted into a patient's gastrointestinal tract.

### BRIEF DESCRIPTION OF THE FIGURES

FIG. 1 is a schematic illustration of a system in accordance with an embodiment of the present invention;

FIG. 2 is a schematic illustration of a system in accordance with another embodiment of the present invention;

FIG. 3 is a schematic illustration of a sampling mechanism including an articulated arm in accordance with an embodiment of the present invention;

FIG. 4 is a schematic illustration of a sampling mechanism including a blade in accordance with an embodiment of the present invention;

FIG. 5 is a schematic illustration of a system including a which is rotatable device in accordance with an embodiment of the present invention;

FIG. 6 is a schematic illustration of a system including a position orientation indicator in accordance with an embodiment of the present invention;

FIG. 7 is a schematic illustration of a device including a suction chamber in accordance with an embodiment of the present invention;

FIG. 8 is a schematic illustration of a device, including a propulsion mechanism in accordance with an embodiment of the present invention;

FIG. 9 is a schematic illustration of a system, including fins in accordance with an embodiment of the present invention;

FIG. 10 is a schematic illustration of a device including a hook in accordance with an embodiment of the present invention;

FIG. 11 is a schematic illustration of a device, including turrets in accordance with an embodiment of the present invention;

FIG. 12 is a schematic illustration of a device, including an internal pusher in accordance with an embodiment of the present invention;

FIG. 13 is a schematic illustration of a device fitted with brushes in accordance with an embodiment of the present invention; and

FIG. 14 is a schematic illustration of a system inside a lumen in accordance with an embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention, but the scope of the invention is not limited to the examples given. Features described with respect to one embodiment may be included in other embodiments though not described therein.

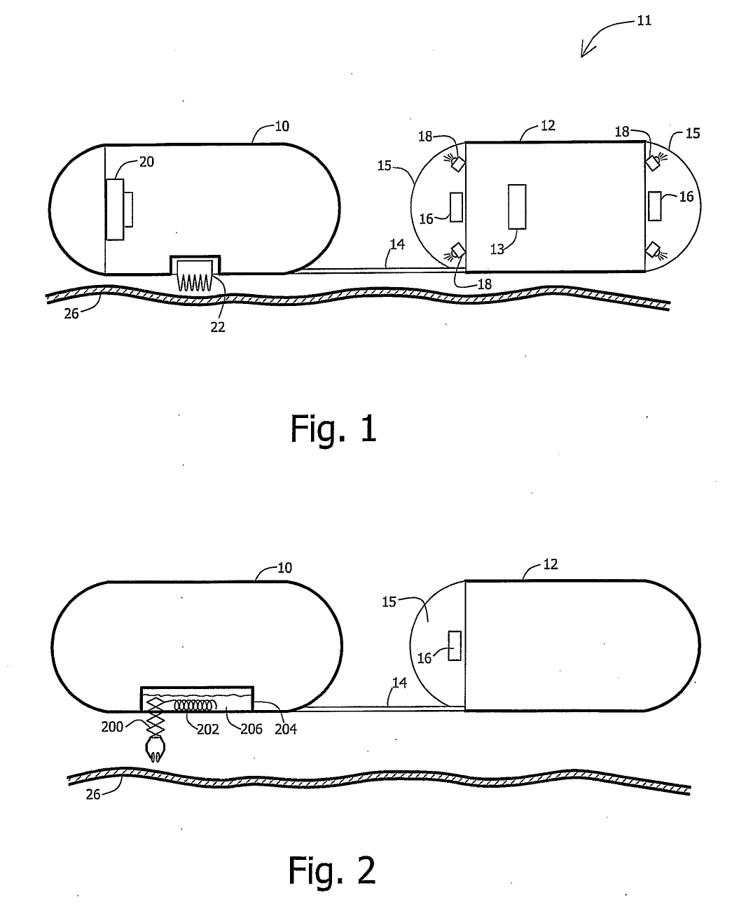

Reference is made to FIG. 1, which schematically illustrates a plurality of connected devices in accordance with an embodiment of the invention. In an embodiment, a system 11 which includes plurality of connected devices 10 and 12 may be introduced into an endo-luminal cavity such as for example the GI tract. The plurality of devices may be connected by, for example, a thread, tube, cable, wire or flexible narrow shaft 14, such that in some embodiments the system 11 might look like a short link of sausages with two or more lobes or links connected by a flexible or partially rigid material. According to some embodiments more than one connecting wire or shaft may be used to connect two or more devices. The connecting wire 14 may physically and/or electrically connect the two devices and may be of any suitable length from a few millimeters to a centimeter or more. The flexible connection between the two devices may make swallowing the system 11 easier and may make the devices more pliable and maneuverable in an in-vivo lumen than would be a single rigid or partially flexible device of the same size or mass.

In some embodiments, for example, one link or lobe could include for example a device 12 which includes an imager(s) 16 and illumination unit(s) 18, typically positioned behind a transparent dome(s) 15, while another lobe could include a device 10 which includes a power source 20, such as a battery and a biopsy or sampling mechanism 22 which may include a storage chamber. In some embodiments, the two devices 10 and 12 may be two independent devices. Other configurations are possible and other components or combinations of components are possible. In some embodiments, one device 10 might pull or push the other device 12 along, for example, as an engine might pull a train.

One device may capture and transmit images of another device; for example of a sampling chamber of another device. For example, images of samples may be transmitted, or images of samples reacting with a substance. In some embodiments, one device 12 that may contain an imager may capture an image of some portion or all, of the other device 10, and perhaps a portion of the GI tract surrounding the device 12 and/or 10. A device that may have an imager 16 at a front and back portion of such device 12 may capture an image of an endo-luminal area with, for example, a front imager and an image of the other connected device with a back imager. In some embodiments an imager could be included in both devices 10 and 12 and the imagers could each view the other device. Similarly, one imager may view an area behind the devices 10 and 12, and another could view an area in front of the devices 10 and 12. One imager may be turned off while another imager may be turned on, or both or neither of the imagers may be turned on at the same time.

One of the devices 10 may for example be fitted with an instrument or set of tools or biopsy mechanism 22 to take a biopsy of endo-luminal tissue, cells or liquid and the other device 12 may for example have an imager 16 and control features to view or direct the biopsy procedure.

The view of an imager 16 may optimally include a biopsy mechanism 22 when it is extended, for example, to grasp a tissue 26. Such a view might let an operator view, supervise and maneuver a biopsy mechanism 22 in real time, and select the location and position for activating the biopsy mechanism 22. Other configurations are possible and it may not be necessary to view the biopsy process with an imager 16.

A system according to some embodiments of the invention may include an in-vivo sensing device transmitting information (e.g., images or other data), typically in a wireless fashion, to a data receiver and/or recorder possibly close to or worn on a subject. A data receiver and/or recorder may have other suitable configurations. The data receiver and/or recorder may transfer the received information to a computing device, such as a workstation or personal computer, where the data may be further analyzed, stored, and/or displayed to a user. In other embodiments, each of the various components need not be required; for example, an internal device may transmit or otherwise transfer (e.g., by wire) information directly to a viewing or processing system.

According to an embodiment of the invention either one or both devices 10 and 12 may include a transmitter 13 for transmitting image data to an external receiving unit. Embodiments of the system and method of the present invention may be used in conjunction with an in-vivo sensing system or device such as described in U.S. Pat. No. 5,604,531 to Iddan et al. and/or in International Application number WO 01/65995 entitled “A Device And System For In-Vivo Imaging”, published on Sep. 13, 2001, and/or U.S. application Ser. No. 10/046,541 filed on Jan. 16, 2002, all of which are hereby incorporated by reference. However, a device, system and method according to various embodiments the present invention may be used with other suitable in-vivo devices. Alternate embodiments of the system and method of the present invention may be used with other devices, such as, non-imaging and/or non-in-vivo devices.

Embodiments of in-vivo devices 10 and/or 12 may typically be autonomous and may typically be self-contained. For example, either of devices 10 and/or 12 may be a capsule or another unit or lobe where all the components may be substantially contained within a container or shell, and where no wires or cables may be required to, for example, receive power or transmit information. According to one embodiment one or more of the in-vivo devices may communicate with an external receiving and display system to provide display of data, control, or other functions. For example, power may be provided by an internal battery (e.g., 20) or a wireless receiving system. According to some embodiments an in vivo device may transmit image or other data to a recorder that is connected in real time to a work station or that is part of a workstation for on line viewing. Other embodiments may have other configurations and capabilities. For example, components may be distributed over multiple sites, links or units. Control information may be received from an external source.

Reference is made to FIG. 2, a device with an articulated arm as a biopsy mechanism in accordance with an embodiment of the invention. A device 10 may be fitted with, for example, an articulated arm 200 that may extend from the device 10 to grasp and collect a piece of tissue 26. Examples of extendable arms that may be used with embodiments of the present invention are described in U.S. patent application Ser. No. 10/694,092 to Iddan and US Provisional Patent Application Number 60/436,003 to Gilad. Other arms and methods may be used. The arm 200 and the endo luminal area to be grasped may be viewed by an imager 16 in the other device 12 so that the biopsy process may be monitored, for example, on an external work station or other display. The extracted tissue 26 may be withdrawn with the articulated arm 200 back into a storage compartment 204 in the device 10 where the tissue 26 may be stored until the device 10 is retrieved. In some embodiments a biopsy sample may be stored in a pocket, compartment 204 or container inside a device 10, and the arm 200 or grasping instrument may be used to retrieve another sample of tissue 26. A curved flat spring 202 that may be released when the arm 200 is retracted may be used to loosen a sample tissue 26 from the arm 200 or biopsy instrument and store the sample in a space or compartment 204 within the device 10. The curved flat spring 202 may be moved out of the way once the arm 200 was re-extended to grasp another sample. The compartment 204 may include a liquid 206, which may be a preservative, saline or a fixation liquid, such that the tissue 26 is kept in a preserving environment until the device 10 is retrieved. Other methods of retrieving and storing a grasped piece of tissue 26 are possible.

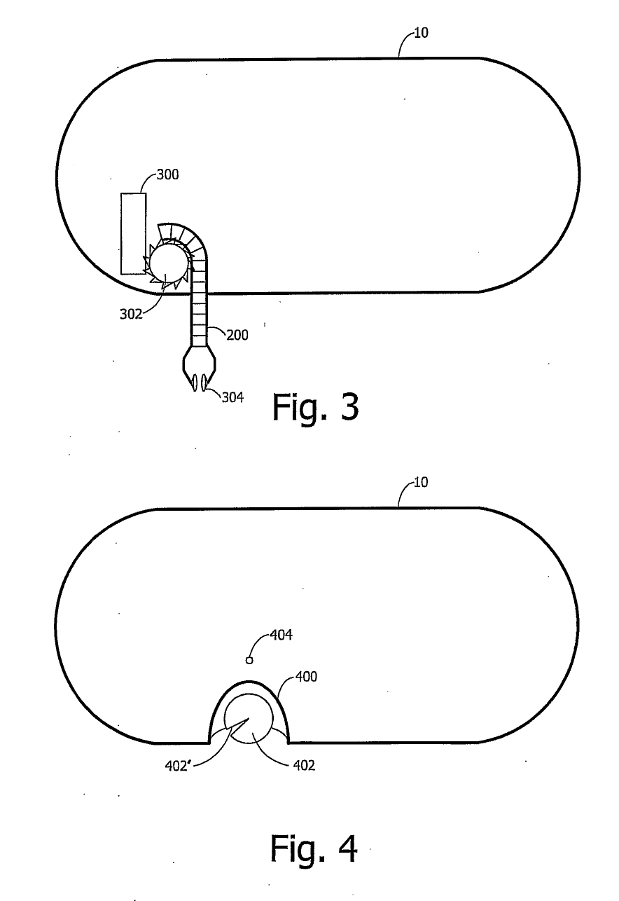

Reference is made to FIG. 3, a schematic depiction of a device with a motor and articulated arm, in accordance with an embodiment of the invention. The arm 200 which may grasp the biopsy sample may be powered by, for example, an electrical motor 300 that may, for example, drive a cog and screw 302 to extend and/or retract the arm 200. Some known motors that may be used in embodiments of the invention may include 1.9 mm motors, MEMS motors and other suitable motors. The forward movement could also close the grasping mechanism 304 of the arm 200. Other methods of retracting the arm 200 are possible such as using a magneto-constrictive alloy or plastic that may extend when a current is applied to it, and retract when the current is removed.

Reference is made to FIG. 4, a schematic depiction of a device with a portal and circular blade in accordance with an embodiment of the invention. Another method of collecting a biopsy of tissue may include using an indentation or portal 400 in a device 10 and having a rotating blade 402 on the inside perimeter of the portal that may slice tissue that comes in contact with the inside of the portal 400. According to one embodiment the blade 402 may be coin shaped with a sharp ended slot (402′) cut in it. The blade 402 may rotate till the sharp ended slot 402′ cuts the tissue that comes in contact with the inside of the portal 400. In some embodiments, a position of the portal 400 where a tissue 26 may be sliced off, may have a mark 404 on the device 10. For example, a mark 404 may indicate the location of the opening of the portal 400, so that an imager viewing the device 10 may readily identify when the portal 400 is in contact or properly oriented with endo-luminal tissue 26, so that the blade 402 or other cutting mechanism may be activated at the right moment. Suction may be used to bring a tissue 26 into the portal 400 where it may be cut.

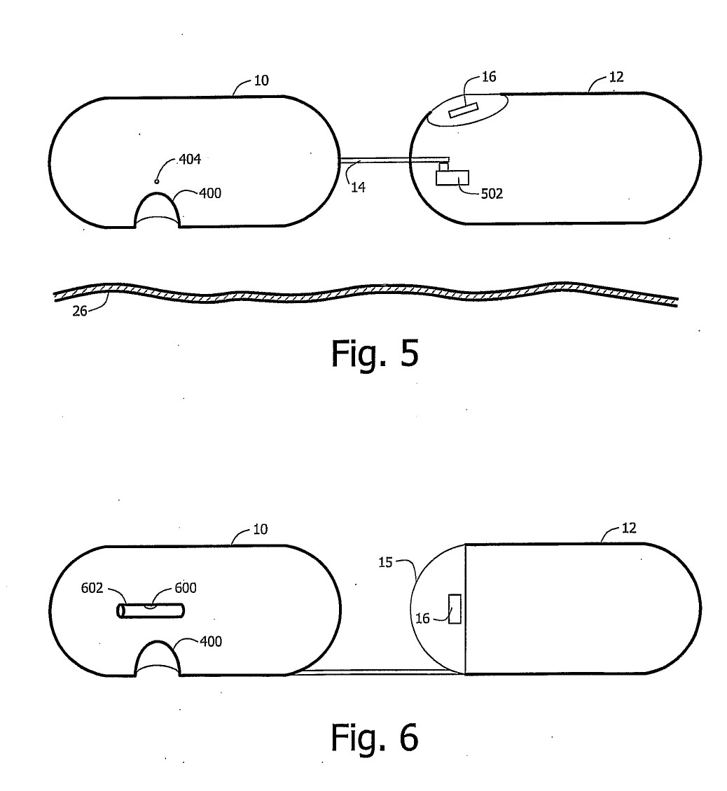

Reference is made to FIG. 5, a schematic depiction of a device that is rotatable, for example, by a motor, in accordance with an embodiment of the invention. In some embodiments, a wire 14 or flexible shaft that may connect devices 10 and 12 may be used to rotate one of the devices 10 so that, for example, a portal 400 may be brought into contact with an endo-luminal wall or tissue 26. A motor 502 or other method of applying rotational force against the wire 14 or shaft may be placed in a first device 12, where an imager 16 may capture a view of the second device 10. The wire 14 or shaft may maneuver the second device 10 into a position where the portal 400 is in contact with a tissue 26 to be sampled. When a marker 404 on the second device 10, that may indicate the proper position of the second device 10, shows that the portal 400 is contiguous to the desired tissue 26, a cutting mechanism may be activated at, for example, the command of an operator and a sample tissue 26 may be cut.

Reference is made to FIG. 6, a schematic depiction of a device with a position/orientation indicator, such as a bubble in a leveling mechanism, in accordance with an embodiment of the invention. In some embodiments bubble container 602 in a device may contain a bubble 600 or mixture of two liquids such as for example oil and water that do not dissolve in each other. The bubble 600 or other leveling mechanism of the two liquids may be used as an indication of the position or orientation of the device 10. For example, if the bubble 600 is centered in a particular area, it may indicate that the device is flat or perpendicular or otherwise in a desired position relative to for example a portal 400 and in a position to capture a tissue 26 sample. In some embodiments, the bubble 600 or combination of liquids may be situated in a transparent area or dome of a device that may be visible in images captured by the device. Such view may be used as an indicator of the position or orientation of the device relative to a portal 400.

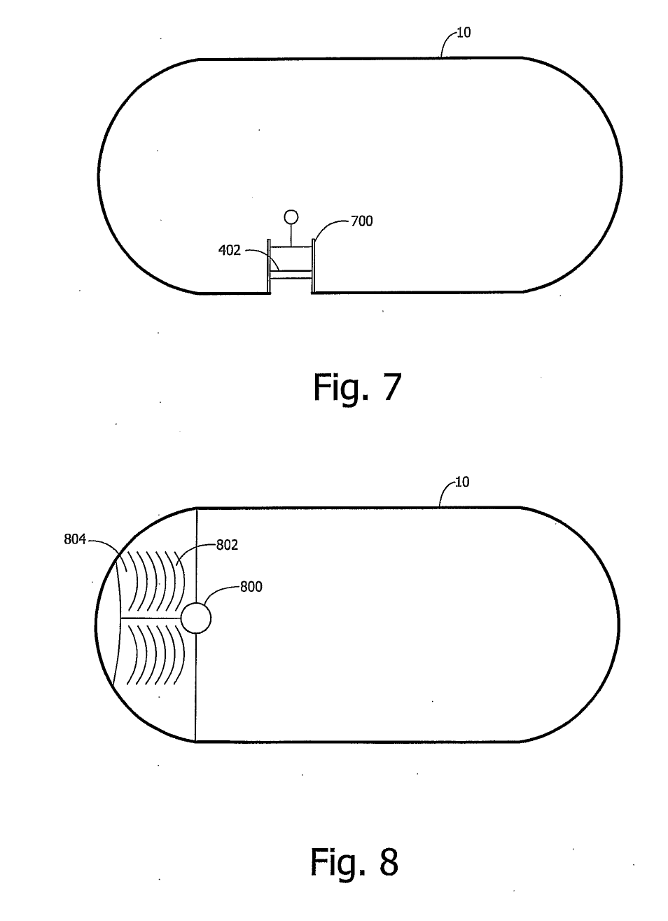

Reference is made to FIG. 7, a schematic depiction of a device with a suction chamber, in accordance with an embodiment of the invention. In some embodiments, suction may be used to pull a piece of tissue into a portal where it may be cut. In some embodiments a series of suction chambers 700 may be included in a device 10, each such chamber 700, possibly having a blade 402 or cutting mechanism to cut a tissue 26 sample. The blade 402 or cutting mechanism could be similar to the one used on the known Crosby, Watson and Quinton capsules. Suction could be used in an autonomous capsule system by incorporating a vacuum within the capsule itself or a connected container and then applying the suction to tissue by opening a small port hole in the capsule or container. The suction could be controlled by valves which may have remote control switches. Other methods of generating suction are possible. The suction may draw into a portal 400 a portion of tissue 26 or other sample to be collected and the sample could be cut with a rotating blade 402. According to some embodiments it may be possible to use an evacuated capsule with a cavity which is closed upon insertion in vivo. When the capsule is in contact with the tissue to be sampled, the cavity may be made to open presenting a vacuumed cavity into which a tissue may be sucked.

Reference is made to FIG. 8, a schematic depiction of a device with a propulsion system, in accordance with an embodiment of the invention. A piston 800 may move backwards and forwards against a membrane 804 inside the cylindrical portion of the device to generate suction. A series of valves 802 may be used to allow air or liquid to be pumped out of a cavity and to apply the resulting suction. An electromagnet that may be alternately turned on and off may supply the power for a pump that may generate suction. An electromagnetic squeeze box type pump may also be used to create suction. Such a squeezebox may also be used to provide propulsion for a device similar to the way that a jelly fish or squid squeezes liquid to provide thrust in a liquid environment. For example, a membrane 804 or diaphragm that may be caused to vibrate within a liquid environment may push on or squeeze water from a container to provide thrust. The container may have or be connected to a series of gill-like valves 802 that may permit intake of liquid to replace the liquid that had been expelled by the membrane. The valves 802 or gills may let water or liquid into the container slowly so as to not move the container backward as the liquid enters. According to some embodiments such a mechanism may be used with a capsule that is close to neutral buoyancy. The membrane 804 may be activated by for example a piston 800 or by electromagnetic force.

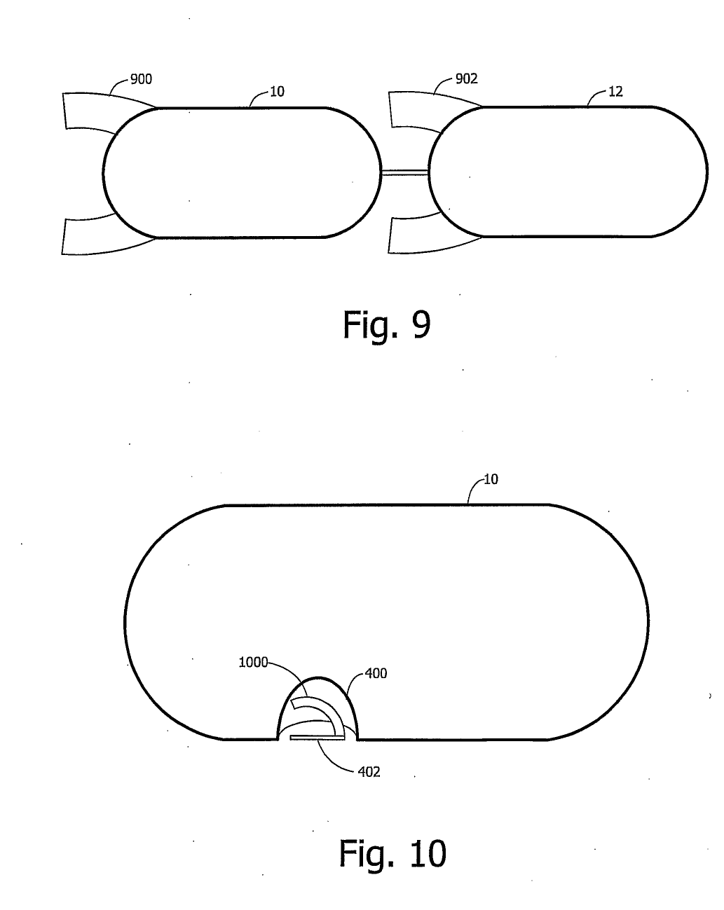

Reference is made to FIG. 9, a schematic depiction of a device with one or more fins or extensions for, for example, rotation, in accordance with an embodiment of the invention. It may be advantageous to have one device in a series of devices rotate more or less frequently than another of the devices. To achieve such result, fins 900 may be added to one device 10, and such fins 900 may be aligned to either cause or deter a rotation of the device 10 in a liquid. For example, fins or other positioning appendages which can be extended from a device in vivo are described in US Patent Application Publication Number 2003/0216622 to Glukhovsky et al., which is hereby incorporated by reference. While one device 10 rotates in the liquid, another of the devices 12 may not rotate, or its fins 902 may be aligned to rotate in another direction. In some embodiments, the fins 900 and/or 902 could be a screw, a soft, umbrella-shaped appendage or a keel.

In some embodiments a small motor may drive a biopsy arm forward to extend the arm towards the desired tissue, and to clamp and remove the tissue. A spring loaded propulsion system for the arm is also possible. The arm may be moved forward by a spring and be retracted by a double trip or spring method, where a first spring may be held compressed and released to punch the biopsy forceps forwards and to close the forceps on the tissue. A second spring may then retract the forceps back into the capsule and seal the opening. A needle or a brush may be used instead of a forceps.

In some embodiments a weight or weighted sensor may be used to indicate when the device or the forceps are facing downwards. For example a pressure sensor could close a circuit when the forceps is pointing directly downwards so that it is known that once the forceps is extended it will reach the desired tissue upon which the device is resting.

According to another embodiment a ballast may be placed in one of the devices so as to ensure a desired position of the device and of a tool, such as forceps, a brush, needle, snare etc.

Reference is made to FIG. 10, a schematic depiction of hooks that may swing out of a device to grab a tissue in accordance with an embodiment of the invention. Instead of or in addition to a spring, one or more hooks or other tools that may have shape memory characteristics, such as for example those obtained with NITINOL (Nickel Titanium) alloys may be loaded into the device. The hook 1000 may be released into an arc like swing, for example, something similar to the shape of a saber tooth tiger's fangs. The hook 1000 may swing or accelerate out of the device and catch onto tissue before swinging back into the device with the tissue in tow, thereby closing up the portal 400 and depositing the tissue 26 inside the device 10. The rotation of a shuttle-like blade 402 might act on the hook to get it to curve into the tissue and lift it up using a sewing machine like action. A corkscrew action may also be used with NITINOL materials and such a corkscrew may be powered by a small motor. The corkscrew may emerge from a side or window of the device and bore into a tissue to grab a sample. It could then retract into the capsule with the grabbed sample of tissue. A double NITINOL hook may also be used.

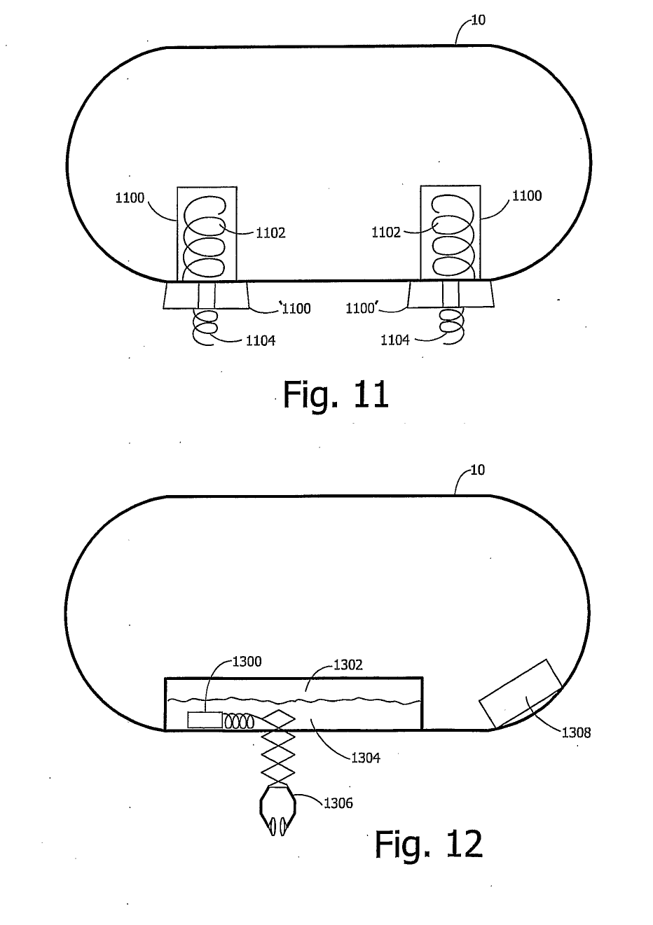

Reference is made to FIG. 11, a schematic depiction of a device with turrets, in accordance with an embodiment of the invention. In some embodiments one or more spring loaded spinning turrets. 1100 may be used to collect a sample of tissue. The spinning turrets may start from a flush position with the device and extend outward and then retract back again following a screw like groove 1102 in the turret. The spinning portion 1100′ of the turret may have a leading curved pin 1104 which may catch the tissue 26 tenting it for the cutter that may follow.

In some embodiments a ‘pinch and tear’ biopsy may be possible using a capsule. While in conventional biopsy methods the tearing is accomplished by pulling back the forceps of a grabbing device, in an autonomous in-vivo device such as device 10, the tearing may be accomplished by the force of peristalsis acting on the arm or other forceps that continue to pinch the tissue. The peristalsis may pull the device 10 thereby resulting in the arm tearing off a piece of tissue and carrying the tissue along with the device. The forceps or arm may then be retracted into the device.

According to further embodiments of the invention a device may include one or more tools, for example, a snare. A forceps or screw or other cutting or tearing appendage with which a capsule or in-vivo device may be equipped may be used to remove a biopsy sample, a polyp or other growth in an in-vivo area. For example a motor, such as described above, could drive a snare, which could close around and pinch a polyp. A wire with a diathermy may be used to surround and remove the polyp or other growth. A current may also be applied to a tissue by a wire or snare or electrode on the outside or shell of the device. The current may burn a tissue away or cut or snare a tissue so that a piece of the tissue remains on the wire that may then be retracted into the device, for example, as described above.

Reference is made to FIG. 12, a depiction of a device with an internal pusher, in accordance with an embodiment of the invention. An internal pusher 1300 may be used inside the device to push collected samples into a receptacle 1302 in the device to free for example the forceps 1306 to allow further biopsies to be taken and stored. The pusher 1300 may include a spring or other suitable element for freeing a sample from forceps 1306 of the sample. The receptacle 1302 that may store biopsy samples may contain formalin, alcohol or some other type of preservative 1304 in which the samples may be stored until they are retrieved. The receptacle 1302 of the capsule which stores the samples may be easily removed after use of the capsule for delivery to a laboratory.

The device may be equipped with a small alarm 1308 or sound alert device that may be activated when the device is released from the body. The alert may be triggered by, for example, an increase in ambient light that would be expected upon the release of the device from the body and may assist in locating the device upon such release. A scanner may be used to scan a toilet or specimen for the device upon its release. The scanner may detect the metallic content of the device or may follow the RF or other electromagnetic waves emitted by the device.

Control of the device or various operations or functions may be enabled with RF or radio controlled switching. Alternatively or in addition, the application of a magnetic field may be used as a control of the device's functions. Similarly, ultrasound, microwave, or internal clock timed (preprogrammed) activations may be used as triggers to activate one or more functions of the device. Various functions may also be triggered in response to changes in environment such as pH, temperature or pressure.

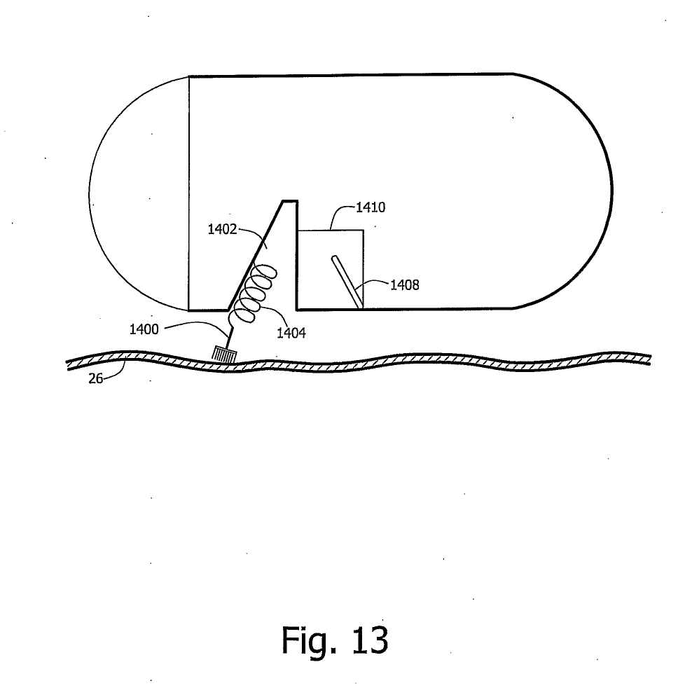

Reference is made to FIG. 13, a depiction of a device fitted with brushes, in accordance with an embodiment of the invention. A device may be fitted with a brush 1400 that may brush tissue from which sample cells are to be taken. A brush 1400 may be adjacent to a slit 1402 in the body of the device and may be held by a spring 1404 that may release the brush 1400 from the device and rotate the brush 1400 against a tissue 26. In some embodiments, a remote controlled window holding the brush may rotate out from the device to push the brush 1400 along. An imager, typically in another attached device may track the position of the brush 1400 to determine when and where it should be released to collect samples. A brush 1400 could be rotated next to an in-vivo site to acquire exfoliate cytological specimens. The rotation could be accomplished by a small motor but could also be achieved with an internal wound spring 1404. There may be a scraper 1408 to receive the cytology specimen and scrape the specimens into a container 1410 in the device, so that the brush may be used again on its passage through a body lumen.

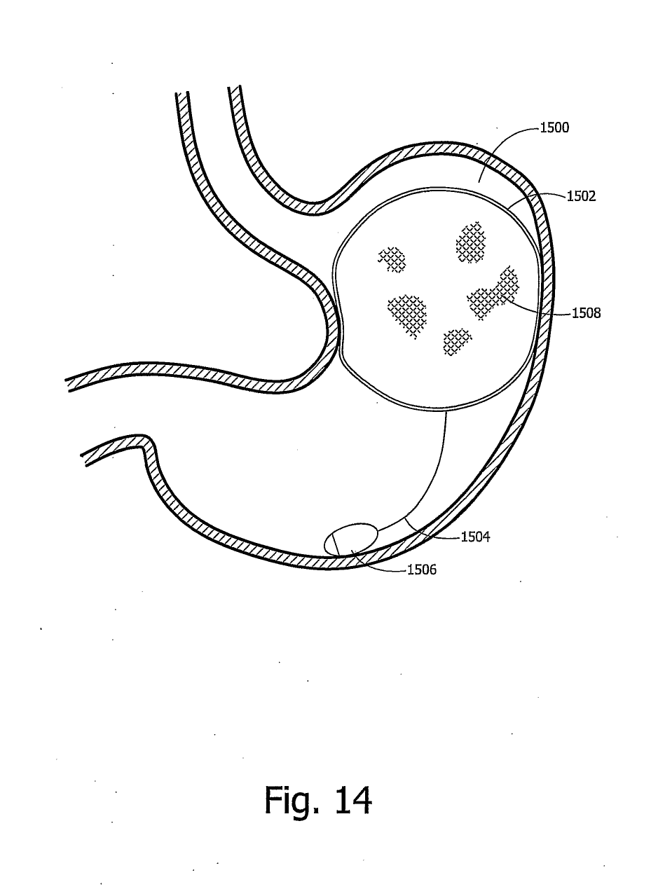

Reference is made to FIG. 14, a depiction of a device with an anchor, e.g., a balloon, in accordance with an embodiment of the invention. In some embodiments, a balloon 1502 may be included in a system and may inflate inside a body lumen, e.g., the stomach 1500. The balloon 1502 may be attached by wire 1504 or thread to a device 1506 which may be held in the stomach 1500 or antrum as long as the balloon 1502 remains inflated. The balloon 1502 may anchor the device 1506. The device 1506 may include a deflated balloon which may be filled with for example sodium bicarbonate or some other expanding material 1508 which may inflate in the presence of water in the stomach 1500 and which may inflate to a specific, predetermined volume. Thus, upon ingestion the balloon 1502 is not inflated to ensure easy swallowing, whereas, when reaching the stomach 1500, the balloon 1502 is inflated and can serve as an anchor. The device 1506 may the move in the body lumen although it remains anchored in the stomach 1500 by the balloon 1502. According to some embodiments the device 1506 may include a motor or may be attached to another device which includes a motor which may pull the device 1506 backwards and forwards towards or away from the balloon 1502, or which may rotate the device 1506 against the balloon 1502 which serves as anchor. Using the balloon 1502 as an anchor and a device 1506 with links 1504 of approximately 3 cm in the stomach 1500 or pylorus looking backwards it may be possible to perform procedures such as Endoscopic Retrograde Cholangiopancreatograph examinations of the liver, pancreas and other organs surrounding the GI tract. Similarly, if a device 1506 is anchored in the stomach 1500 so that it looks at the ampulla it may be possible to direct a wire guide into the bile duct.

Some systems according to embodiments of the invention may include a plurality of devices connected, for example as described above. According to an embodiment one device can be immobilized to a lumen wall, for example, by using pins or grabbers or as described, for example, in WO 02/26103 to Meron et al., so as to anchor the other device to a desired area in the body lumen.

In another embodiment of the invention, there is provided a method for obtaining an in vivo sample, the method comprising: inserting in a body lumen a plurality of connected devices; wherein one device comprises an imager and a transmitter for transmitting image data; and another device comprises a sampling mechanism; transmitting images of the other device; and controlling the sampling mechanism.

It will be appreciated by persons skilled in the art that the present invention is not limited to what has been particularly shown and described hereinabove. Alternate embodiments are contemplated which fall within the scope of the invention.

1-19. (canceled)

20. An autonomous system for obtaining a sample from within a body lumen, comprising:
a first self-contained device comprising an imager and a transmitter for transmitting in vivo data; and
a second self-contained device connected to said first device, wherein said second device comprises a sampling mechanism.

21. The system of claim 20, wherein said second device comprises a storage compartment.

22. The system of claim 20, wherein said first device comprises an illumination unit.

23. The system of claim 20, wherein said sampling mechanism comprises a unit selected from the group consisitng of: an articulated arm, a blade, a suction mechanism, forceps, a brush, a needle, a spinning turret, and a snare.

24. The system of claim 20, comprising a data receiver.

25. The system of claim 20, wherein said connection between said first device and said second device comprises a flexible connection.

26. The system of claim 20, wherein said connection between said first device and said second device comprises a connection selected from the group consisting of a wire, a shaft, a tube, a thread, and a cable.

27. The system of claim 20, wherein said storage compartment includes a liquid.

28. The system of claim 27, wherein said liquid comprises a liquid selected from the group consisting of a preservative, saline, and a fixation liquid.

29. The system of claim 20, wherein said second device comprises an articulated arm and a cutting mechanism.

30. The system of claim 20, wherein said second device comprises an articulated arm to collect a sample and a spring to loosen the sample from said articulated arm.

31. The system of claim 20, wherein said second device comprises a portal and a blade on an inside perimeter of the portal.

32. The system of claim 20, wherein said second device comprises a position/orientation indicator.

33. The system of claim 20, wherein said second device comprises an anchor.

34. The system of claim 33, wherein said anchor is a balloon.

35. The system of claim 20, wherein said second device comprises fins.

36. The system of claim 20, comprising a propulsion system.

38. A method for obtaining a sample from within a body lumen, from an autonomous system, the method comprising:
transmitting images from a first device; and
obtaining the sample by a second device, wherein said second device is coupled to said first device, and wherein said transmitted images from said first device include images of the second device.

38. The method of claim 37, comprising controlling said second device.

39. An autonomous system for obtaining a sample from within a body lumen, comprising:
a first self-contained device comprising an imager and a transmitter for transmitting in vivo data; and
a second self-conatined device connected to said first device, wherein said second device comprises a sampling mechanism;
wherein at least one of said devices comprises a propulsion system for suction and thrusting.
